(19) United States
(12) Patent Application Publication
(10) Pub. No.: US 2017/0359604 A1
(43) Pub. Date: Dec. 14, 2017

(54) ADVERTISEMENT PROVIDING METHOD, AND TERMINAL USING SAME

(71) Applicant: SK Planet Co., Ltd., Gyeonggi-do (KR)

(72) Inventor: Ju Tae KIM, Gyeonggi-do (KR)

(73) Assignee: SK Planet Co., Ltd., Gyeonggi-do (KR)

(21) Appl. No.: 15/322,654

(22) PCT Filed: Dec. 8, 2015
(86) PCT No.: PCT/KR2015/013352

§ 371 Date: Dec. 28, 2016

(30) Foreign Application Priority Data
Jan. 9, 2015 (KR) 10-2015-0003314

(51) Int. Cl. H04N 21/234; H04N 21/442; H04N 21/414; H04N 21/81; G06Q 30/02

(52) U.S. Cl. CPC H04N 21/23424; H04N 21/812; G06Q 30/0267; H04N 21/41407; H04N 21/44227

(57) ABSTRACT

Disclosed herein are a method of providing advertisements without combining broadcast contents with advertisements, and a terminal performing the method. The terminal carried by a viewer checks a viewing condition of the viewer based on a beacon signal transmitted from a viewing device, and a separate service server provides a targeted advertisement to the terminal by using the viewing condition checked by the terminal.

### TECHNICAL FIELD

The present disclosure relates to a scheme in which a terminal carried by a viewer checks a viewing condition of the viewer based on a beacon signal transmitted from a viewing device, and a separate service server provides a targeted advertisement to the terminal by using the viewing condition checked by the terminal.

### BACKGROUND ART

Recently, as interactive digital broadcasting evolves, there has been proposed a manner of providing advertisements in association with broadcast contents that a viewer is currently watching in real-time.

In such a manner, broadcast contents including advertisements such as product information or additional information may be transmitted, or the advertisements received by a broadcast viewing device (e.g., a smart TV, a set top box) may be transmitted to a smart device (hereinafter, referred to as a terminal) carried by a viewer.

However, the above manner requires a process of inserting advertisements into broadcast contents in advance, and targets receiving the advertisements are not specified and thus it is not possible to guarantee that the advertisements would be successful.

### DISCLOSURE

### Technical Problem

To address the above described problems, it is an object of the present disclosure to provide targeted advertisements to viewers without combining broadcast contents with advertisements, in such a manner that the terminal carried by a viewer checks a viewing condition of the viewer based on a beacon signal transmitted from a viewing device, and a separate service server provides a targeted advertisement to the terminal by using the viewing condition checked by the terminal.

### Technical Solution

In accordance with one aspect of the present disclosure, a terminal includes: an extracting unit configured to extract viewing information from a beacon signal received from a viewing device; a checking unit configured to check if a viewing condition associated with the viewing device has been changed based on the viewing information; and a transmitting unit configured to transmit the viewing information to a service server so that an advertisement associated with the changed viewing condition is received from the service server, when it is determined that the viewing condition has been changed.

The terminal may further include: a determining unit configured to determine whether the terminal is able to receive the beacon signal; and a switching unit configured to switch beacon reception capability from an inactive state to an active state to allow the terminal to receive the beacon signal, when it is determined that the terminal is able to receive the beacon signal.

The determining unit may determine that the terminal is able to receive the beacon signal when the terminal has entered a predetermined broadcast viewing area, and the broadcast viewing area may be set as an area where the terminal has received the advertisement and/or an area where a predetermined function of the terminal has executed at a particular time zone.

The viewing information may contain at least one of a power state of the viewing device, a channel state of the viewing device and a spacing distance between the viewing device and the terminal, and the checking unit may determine that the viewing condition has been changed when at least one of the power state, the channel state and the spacing distance has been changed.

In accordance with another aspect of the present disclosure, a method performed by a terminal includes: extracting viewing information from a beacon signal received from a viewing device; checking if a viewing condition associated with the viewing device has been changed based on the viewing information; and transmitting the viewing information to a service server so that an advertisement associated with the changed viewing condition is received from the service server, when it is determined that the viewing condition has been changed.

The method may further include: determining whether the terminal is able to receive the beacon signal; and switching beacon reception capability from an inactive state to an active state to allow the terminal to receive the beacon signal, when it is determined that the terminal is able to receive the beacon signal.

The determining may include determining that the terminal is able to receive the beacon signal when the terminal has entered a predetermined broadcast viewing area, and the broadcast viewing area may be set as an area where the terminal has received the advertisement and/or an area where a predetermined function of the terminal has executed at a particular time zone.

The beacon signal may contain at least one of a power state of the viewing device, a channel state of the viewing device and a spacing distance between the viewing device and the terminal, and the checking may include determining that the viewing condition has been changed when at least one of the power state, the channel state and the spacing distance has been changed.

### Advantageous Effects

According to advertisement providing method and a terminal employed by the method of the present disclosure, targeted advertisements can be provided to viewers without combining broadcast contents with advertisements in such a manner that the terminal carried by a viewer checks a viewing condition of the viewer based on a beacon signal transmitted from a viewing device, and a separate service server provides a targeted advertisement to the terminal by using the viewing condition checked by the terminal.

### DESCRIPTION OF DRAWINGS

FIG. 1 is a view showing an advertising system according to an exemplary embodiment of the present disclosure;

FIG. 2 is a block diagram of a terminal according to an exemplary embodiment of the present disclosure;

FIG. 3 is a flowchart illustrating operation flow in an advertising system according to an exemplary embodiment of the present disclosure; and

FIG. 4 is a flowchart illustrating operation flow in a terminal according to an exemplary embodiment of the present disclosure.

### BEST MODE

It is noted that the technical terms used herein are used only to describe specific embodiments and are not intended to limit the scope of the teachings disclosed herein. Also, the technical terms used herein should be interpreted in a sense that is generally understood by a person having ordinary skill in the art to which the presently disclosed technology belongs, unless the context clearly dictates otherwise and should not be construed in a broader sense or in an oversimplified sense. In addition, where technical terms used herein are inappropriate to exactly express the technical idea disclosed herein, they should be replaced with technical terms that allow the person in the art to properly understand. Also, the general terms used in the present disclosure should be interpreted in accordance with definitions in the dictionary and the predefined or prior context, and should not be construed as being excessively reduced in meaning.

As used herein, the singular form of “a,” “an,” and “the” include plural references unless the context clearly dictates otherwise. As used herein, the terms “consisting of,” “comprising,” etc., should not be construed as necessarily including all of the elements or steps listed thereafter, but some of the elements or steps may be omitted or additional elements or steps may further included.

Furthermore, the terms first, second and the like in the description and in the claims are used for distinguishing between similar elements and not necessarily for describing a sequential or chronological order. The terms are used only for distinguishing one component from another component. The terms so used are interchangeable under appropriate circumstances, e.g., a first component may be referred to as a second component and vice versa without departing from the scope of the present disclosure.

In the following detailed description, exemplary embodiments of the present disclosure will be described in detail with reference to the accompanying drawings. Throughout the drawings, like elements will be denoted by the same reference numerals and redundant descriptions will be omitted.

Detailed descriptions of well-known functions and structures incorporated herein will be omitted to avoid obscuring the gist of the technology disclosed herein. In addition, it is to be noted that the accompanying drawings are provided merely to facilitate understanding of the technical idea disclosed herein and that the scope of the technical idea is not limited thereby.

Hereinafter, an exemplary embodiment of the present disclosure will be described with reference to the accompanying drawings.

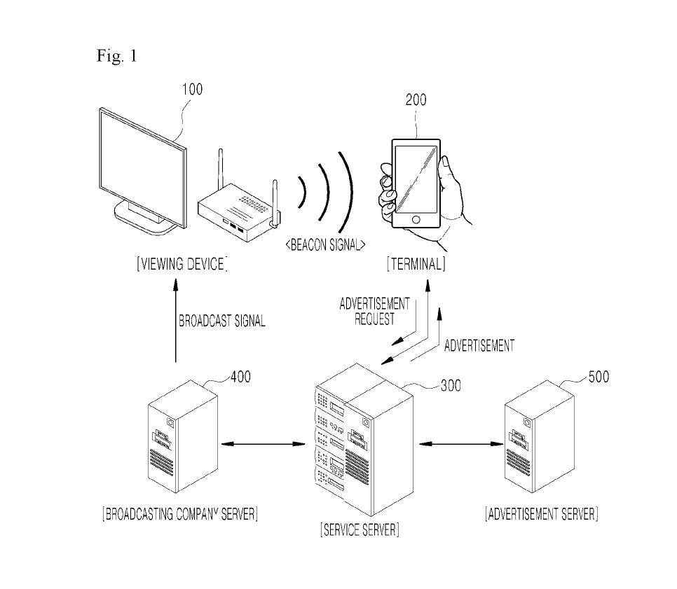

FIG. 1 is a view showing an advertising system according to an exemplary embodiment of the present disclosure.

As shown in FIG. 1, the advertising system according to the exemplary embodiment of the present disclosure may include a viewing device 100 that receives broadcast signals, a terminal carried by a viewer 200, and a service server 300 that provides advertisements to the terminal 200.

The advertising system according to an exemplary embodiment of the present disclosure may further include a broadcasting company server 400 that transmits broadcast signals to the viewing device 100 via wired/wireless communications networks, and an advertisement server 500 that stores advertisements, as well as the above-described elements.

The viewing device 100 refers to a device that receives broadcast signals transmitted from the broadcasting company server 400. In addition to receiving broadcast signals, the viewing device 100 supports beacon capability such that it may transmit beacon signals associated with the broadcast signals.

For example, the viewing device 100 may include, but is not limited to, a smart TV, a set top box, etc. The viewing device 100 may include any device capable of receiving broadcast signals and supporting the beacon capability.

Although the beacon capability supported by the viewing device 100 is described as a feature integrally equipped with the viewing device 100 in this exemplary embodiment, it is to be understood that the beacon capability may also implemented as a separate element from the viewing device 100.

The terminal 200 refers to a smart device that is carried by a viewer and receives a beacon signal transmitted from the viewing device 100.

For example, the terminal 200 may include, but is not limited to, a smartphone, a table PC, a PDA, and a laptop computer. The terminal 200 may include any smart device capable of supporting reception of beacon signals.

The service server 300 refers to a server that provides advertisements to the terminal 200. The service server 300 uses program guide information on each of broadcasting channels provided from the broadcasting company server 400 to select a targeting advertisement that is the most suitable for the terminal 200 from among advertisements stored in the advertisement server 500.

For example, the service server 300 may be a home shopping server. In that example, the expected advertisements provided to the terminal 200 may be information on a product on air, information on a related product, etc.

According to an exemplary embodiment of the present disclosure, an advertisement associated with a broadcast content that a viewer is currently watching is provided in real-time on the viewing device 100.

As such, to provide advertisements associated with broadcast contents in real-time, it is typical to transmit the broadcast contents including the advertisements such as information on a product or additional information or to transmit the advertisements received by the viewing device 100 to a smart device (hereinafter, referred to as a terminal) carried by a viewer.

Unfortunately, such manner requires a process of directly inserting an advertisement into a broadcast content in advance.

Specifically, such manner requires additional processes including: using program guide information for each of broadcasting channels provided from the broadcasting company server 400 to check a broadcast content for each of the broadcasting channels at a given broadcasting time; and inserting an advertisement associated with the checked broadcast content into the respective broadcast signal in advance.

Moreover, although it can be expected from the existing manner that advertisement effect can be increased by providing advertisements in association with the broadcast contents, the existing manner cannot provide an advertisement suitable (targeted advertisement) for characteristics of each individual who is watching broadcast contents (e.g., age, hobby, regional preference). Accordingly, actually the advertisement effect may not come up to the expectation.

In view of the above, according to an exemplary embodiment of the present disclosure, there is provided an approach that can provide a targeted advertisement to a viewer without the process of directly inserting an advertisement into a broadcast content. Hereinafter, each of the elements of a system for achieving it will be described in detail.

The viewing device 100 may transmit beacon signals.

More specifically, the viewing device 100 checks the current power state (ON/OFF) and a broadcast channel that a viewer is watching at predetermined intervals and inserts the checked information into a beacon signal to transmit it.

The beacon signal may contain a universally unique identifier (UUID), major code of 2 bytes, minor code of 2 bytes, for example.

The viewing device 100 inserts its identification information into the UUID and inserts other information such as the power state (ON/OFF) and information associated with the broadcast channel that a viewer is watching into the major code and/or the minor code to transmit it as a beacon signal.

The terminal 200 may switch the beacon reception capability into its active state.

More specifically, prior to receiving the beacon signal transmitted from the viewing device 100, the terminal 200 may determine whether to switch the beacon reception capability from its inactive state into its active state.

By determining whether to activate the beacon reception capability or not, it is possible to allow the beacon reception capability to be in the inactive state normally and to be switched to the active state only when the beacon signal can be received, thereby saving power consumption.

The terminal 200 determines that it can receive a beacon signal if it currently enters a predetermined broadcast viewing area based on location information.

The broadcast viewing area refers to an area where a viewer carrying the terminal 200 is likely to watch broadcasting, e.g., an area in the house.

Such broadcast viewing area may be set as, but is not limited to, an area where the terminal 200 has received an advertisement previously by using a beacon signal, and an area where a predetermined function (e.g., screen-on, unlocking, an alarm, replacement of a battery) has been executed in the terminal 200 at a particular time zone (e.g., in the morning, at dawn or at midnight).

Accordingly, if it is determined in the above-described manner that the terminal 200 can receive a beacon signal, the beacon reception capability is switched from the inactive state to the active state, such that it can receive the beacon signal transmitted from the viewing device 100.

The terminal 200 may extract viewing information.

More specifically, when the terminal 200 receives a beacon signal transmitted from the viewing device 100, the terminal 200 may extract the viewing information from the received beacon signal.

The viewing information may contain the power state (ON/OFF) of the viewing device 100, a channel state of the viewing device 100, and a spacing distance between the viewing device 100 and the terminal 200, for example.

That is, the terminal 200 may identify the viewing device 100 based on the UUID contained in a beacon signal, and may check the power state (ON/OFF) and the channel state of the viewing device 100 based on the major code and/or the minor code.

Additionally, the terminal 200 may determine the spacing distance between the viewing device 100 and a viewer by using the strength of the received beacon signal. The spacing distance may be used later on to determine whether the viewer is actually watching a broadcast content.

In addition, the terminal 200 may check if a viewing condition has been changed.

More specifically, when the viewing information is extracted from a beacon signal, the terminal 200 checks if the viewing condition has been changed by using the extracted viewing information.

By checking if the viewing condition is changed in this manner, it is possible to request from the service server 300 an advertisement by reflecting the changed viewing condition.

To this end, the terminal 200 compares previously extracted viewing information with currently extracted viewing information to determine whether the viewing condition has been changed.

In addition, the terminal 200 may request an advertisement.

More specifically, if the terminal 200 determines that the viewing condition has been changed by using the extracted viewing information, it transmits the extracted viewing information to the service server 300 to request an advertisement suitable for the changed viewing condition.

There are conditions for requesting an advertisement from the service server 300. For example, it should be checked from the viewing information that the viewing device 100 has been powered on, that a particular broadcast channel is being watched, and that a viewer carrying the terminal 200 has to be within a distance from the viewing device 100 so that she/he can actually watch a broadcast content.

By doing so, an advertisement is provided to a viewer carrying the terminal 200 only when the viewer is actually watching a broadcast content, thereby increasing the efficiency of the advertisement.

The service server 300 may provide advertisements.

More specifically, when the viewing information is received from the terminal 200 and the advertisement is requested, the service server 300 checks a specific broadcast channel currently viewed by the viewer using the viewing information received from the terminal 200 and provides the terminal 200 with the advertisement suitable for the broadcast content currently broadcasted on the specific broadcast channel.

The service server 300 may operate an advertisement scheduler creating a group of candidate advertisements from the advertisement server 500 for each of the broadcasting channels based on the current time and program guide information for each of the broadcasting channels provided from the broadcasting company server 400.

By doing so, the service server 300 selects an optimal advertisement from among the group of candidate advertisements to be exposed at the current time by using the advertisement scheduler for each of the channels based on a consumer context such as subscriber information of each of the viewers watching the broadcast content and their purchase histories, etc., to provide it to the terminal 200.

To this end, the service server 300 may cooperate with the terminal 200 to write and update in advance the consumer context such as the subscriber information of each of the viewers and the purchase histories, etc., in addition to the cooperation with the broadcasting company server 400 and the advertisement server 500.

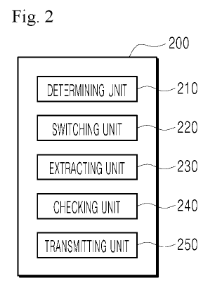

Hereinafter, the configuration of the terminal 200 according to an exemplary embodiment of the present disclosure will be described in more detail with reference to FIG. 2.

As shown in FIG. 2, the terminal 200 according to an exemplary embodiment of the present disclosure may include a determining unit 210 to determine whether a beacon signal can be received, a switching unit 220 to switch the beacon signal reception capability between inactive and active states, an extracting unit 230 to extract viewing information, a checking unit 240 to check if the viewing condition has been changed, and a transmitting unit 250 to transmit the viewing information and request an advertisement.

It is to be noted that all or at least some of the above-described determining unit 210, the switching unit 220, the extracting unit 230, the checking unit 240 and the transmitting unit 250 may be implemented in software module or hardware module driven by an application or a combination of software and hardware modules.

Accordingly, with the above-described elements, the advertisement providing apparatus 200 according to an exemplary embodiment of the present disclosure can provide a targeted advertisement to a viewer without a process of directly inserting an advertisement into a broadcast content. Hereinafter, each of the elements in the terminal 200 will be described in detail below.

The determining unit 210 may determine whether a beacon signal can be received.

More specifically, prior to receiving the beacon signal transmitted from the viewing device 100, the determining unit 210 may determine whether to switch the beacon reception capability from its inactive state into its active state.

By determining whether to activate the beacon reception capability or not, it is possible to allow the beacon reception capability to be in the inactive state normally and to be switched to the active state only when the beacon signal can be received, thereby saving power consumption.

The determining unit 210 determines that it can receive a beacon signal if it currently enters a predetermined broadcast viewing area based on location information.

The location information may be acquired in a variety of ways, e.g., using a GPS, base station information, the strength of a received Wi-Fi signals, etc. However, this is merely illustrative.

The broadcast viewing area refers to an area where a viewer carrying the terminal 200 is likely to watch broadcasting, e.g., an area in the house.

Such broadcast viewing area may be set as, but is not limited to, an area where the terminal 200 has received an advertisement previously by using a beacon signal, and an area where a predetermined function (e.g., unlocking, an alarm, replacement of a battery) has been executed in the terminal 200 at a particular time zone (e.g., in the morning, at dawn or at midnight).

If any of the functions of the unlocking, an alarm and the replacement of a battery is executed in the terminal 200 in the morning, at dawn or at midnight, it may mean that a viewer carrying the terminal 200 is in the house, i.e., within the broadcast viewing area.

The switching unit 220 may switch the beacon reception capability into its active state.

More specifically, if it is determined that the terminal 200 has entered the broadcast viewing area and can receive a beacon signal, the beacon reception capability is switched from the inactive state to the active state, such that it can receive the beacon signal transmitted from the viewing device 100.

The extracting unit 230 may extract viewing information.

More specifically, when the extracting unit 230 receives a beacon signal transmitted from the viewing device 100, it may extract the viewing information from the received beacon signal.

The extracting unit 230 may identify the viewing device 100 based on the UUID contained in a beacon signal, and may check the power state (ON/OFF) and the channel state of the viewing device 100 based on the major code and/or the minor code.

Additionally, the extracting unit 230 may determine the spacing distance between the viewing device 100 and a viewer by using the strength of the received beacon signal. The spacing distance may be used to determine whether the viewer is actually watching a broadcast content.

The checking unit 240 may check if a viewing condition is changed.

More specifically, when the checking unit 240 extracts the viewing information from a beacon signal, it checks if the viewing condition is changed by using the extracted viewing information.

By checking if the viewing condition is changed in this manner, it is possible to request from the service server 300 an advertisement by reflecting the changed viewing condition.

To this end, the checking unit 240 compares previously extracted viewing information with currently extracted viewing information to determine whether the viewing condition has been changed.

For example, it may be determined that the viewing condition has been changed if a viewer is watching a particular broadcasting channel after the viewing device 100 is turned on by comparing the previously extracted viewing information with the currently extracted viewing information.

For another example, it may also be determined that the viewing condition has been changed if it is checked that a viewer was out of the distance within which she/he can watch a broadcast content and then comes within the distance by comparing previously extracted viewing information with currently extracted viewing information.

In addition, it may also be determined that the viewing condition has been changed if it is checked that a broadcasting channel has been changed by comparing the previously extracted viewing information with the currently extracted viewing information.

The transmitting unit 250 may request advertisements.

More specifically, if the transmitting unit 250 determines that the viewing condition has been changed by using the extracted viewing information, it transmits the extracted viewing information to the service server 300 to request an advertisement suitable for the changed viewing condition.

There are conditions for requesting an advertisement from the service server 300. For example, it should be checked from the viewing information that the viewing device 100 has been powered on, that a particular broadcast channel is being watched, and that a viewer carrying the terminal 200 has to be within a distance from the viewing device 100 so that she/he can actually watch a broadcast content.

By doing so, an advertisement is provided to a viewer carrying the terminal 200 only when the viewer is actually watching a broadcast content, thereby increasing the efficiency of the advertisement.

In this regard, when the viewing information is received from the terminal 200 and the advertisement is requested, the service server 300 checks a specific broadcast channel currently viewed by the viewer using the viewing information received from the terminal 200 and provides the terminal 200 with the advertisement suitable for the broadcast content currently broadcasted on the specific broadcast channel.

As set forth above, in the advertising system and the terminal 200 according to an exemplary embodiment of the present disclosure, targeted advertisements can be provided to viewers without combining broadcast contents with advertisements, in such a manner that the terminal 200 carried by a viewer checks a viewing condition of the viewer based on a beacon signal transmitted from the viewing device 100, and the separate service server 300 provides a targeted advertisement to the terminal 200 by using the viewing condition checked by the terminal 200.

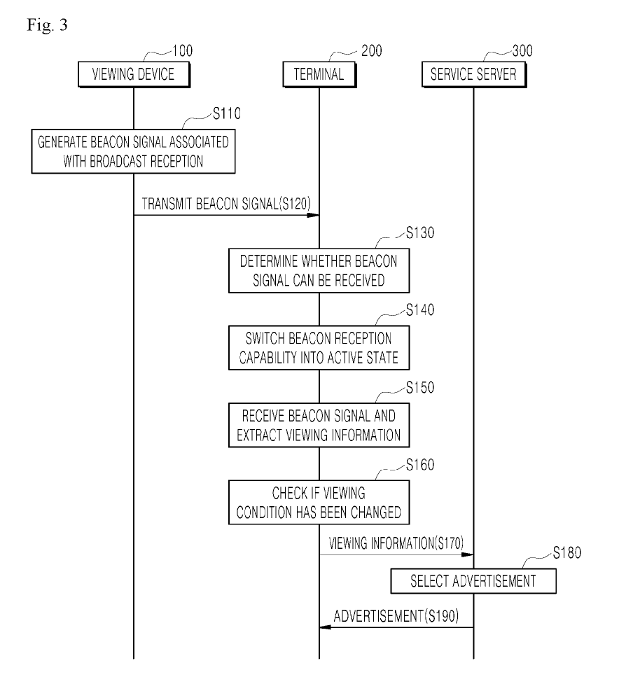

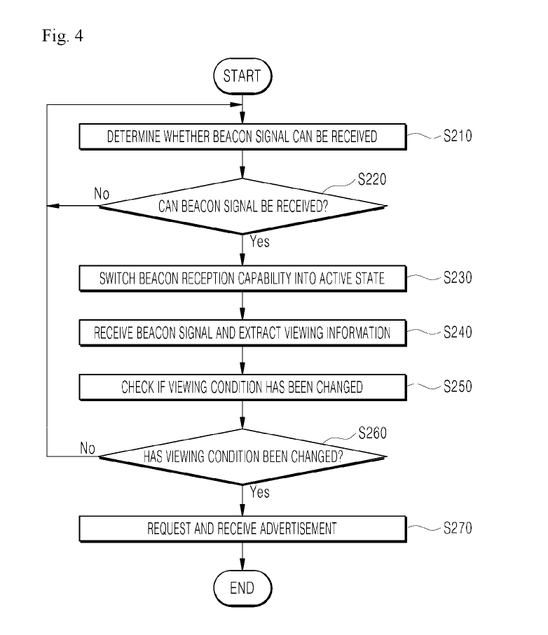

Hereinafter, a method for providing an advertisement according to an exemplary embodiment of the present disclosure will be described with reference to FIGS. 3 and 4. For convenience of illustration, the same reference numerals as those of FIGS. 1 and 2 are used in the following description.

Initially, the operation flow in an advertising system according to an exemplary embodiment of the present disclosure will be described in detail with reference to FIG. 3.

Initially, the viewing device 100 checks the current power state (ON/OFF) and a broadcast channel that a viewer is watching at predetermined intervals and inserts the checked information into a beacon signal to transmit it (steps S110 and S120).

The viewing device 100 inserts its identification information into the UUID and inserts other information such as the power state (ON/OFF) and information associated with the channel that a viewer is watching into the major code and/or the minor code to transmit it as a beacon signal.

Subsequently, prior to receiving the beacon signal transmitted from the viewing device 100, the terminal 200 may determine whether to switch the beacon reception capability from its inactive state into its active state (step S130).

The terminal 200 determines that it can receive a beacon signal if it currently enters a predetermined broadcast viewing area based on location information.

Subsequently, if it is determined in the above-described manner that the terminal 200 can receive a beacon signal, the beacon reception capability is switched from the inactive state to the active state, such that it can receive the beacon signal transmitted from the viewing device 100 (step S140).

Subsequently, when the terminal 200 receives a beacon signal transmitted from the viewing device 100, the terminal 200 may extract the viewing information from the received beacon signal (step S150).

The terminal 200 may identify the viewing device 100 based on the UUID contained in a beacon signal, and may check the power state (ON/OFF) and the channel state of the viewing device 100 based on the major code and/or the minor code.

Additionally, the terminal 200 may determine the spacing distance between the viewing device 100 and a viewer by using the strength of the received beacon signal. The spacing distance may be used to determine whether the viewer is actually watching a broadcast content.

Subsequently, when the terminal 200 extracts the viewing information from a beacon signal, it checks if the viewing condition is changed by using the extracted viewing information (Step S160).

The terminal 200 compares previously extracted viewing information with currently extracted viewing information to determine whether the viewing condition has been changed.

Moreover, if the terminal 200 determines that the viewing condition has been changed by using the extracted viewing information, it transmits the extracted viewing information to the service server 300 to request an advertisement suitable for the changed viewing condition (step S170).

Subsequently, when the viewing information is received from the terminal 200 and the advertisement is requested, the service server 300 checks a specific broadcast channel currently viewed by the viewer using the viewing information received from the terminal 200 and provides the terminal 200 with the advertisement suitable for the broadcast content currently broadcasted on the specific broadcast channel (steps S180 and S190).

At this time, the service server 300 selects an optimal advertisement from among the group of candidate advertisements to be exposed at the current time by using the advertisement scheduler for each of the channels based on a consumer context such as subscriber information of each of the viewers watching the broadcast content and their purchase histories, etc., to provide it to the terminal 200.

Hereinafter, the operation of the terminal 200 according to an exemplary embodiment of the present disclosure will be described in detail with reference to FIG. 4.

Initially, prior to receiving the beacon signal transmitted from the viewing device 100, the determining unit 210 may determine whether to switch the beacon reception capability from its inactive state into its active state (step S210).

The terminal 200 determines that it can receive a beacon signal if it currently enters a predetermined broadcast viewing area based on location information.

The broadcast viewing area refers to an area where a viewer carrying the terminal 200 is likely to watch broadcasting, e.g., an area in the house.

Such broadcast viewing area may be set as, but is not limited to, an area where the terminal 200 has received an advertisement previously by using a beacon signal, and an area where a predetermined function (e.g., unlocking, an alarm, replacement of a battery) has been executed in the terminal 200 at a particular time zone (e.g., in the morning, at dawn or at midnight).

Then, if it is determined that the terminal 200 has entered the broadcast viewing area and can receive a beacon signal, the switching unit 220 may switch the beacon reception capability from the inactive state to the active state, such that it can receive the beacon signal transmitted from the viewing device 100 (steps S220 and S230).

Then, when the extracting unit 230 receives a beacon signal transmitted from the viewing device 100, it may extract the viewing information from the received beacon signal (step S240).

The extracting unit 230 may identify the viewing device 100 based on the UUID contained in a beacon signal, and may check the power state (ON/OFF) and the channel state of the viewing device 100 based on the major code and/or the minor code.

Additionally, the extracting unit 230 may determine the spacing distance between the viewing device 100 and a viewer by using the strength of the received beacon signal. The spacing distance may be used to determine whether the viewer is actually watching a broadcast content.

Subsequently, when the checking unit 240 extracts the viewing information from a beacon signal, it checks if the viewing condition is changed by using the extracted viewing information (Step S250).

By checking if the viewing condition is changed in this manner, it is possible to request from the service server 300 an advertisement by reflecting the changed viewing condition.

To this end, the checking unit 240 compares previously extracted viewing information with currently extracted viewing information to determine whether the viewing condition has been changed.

Subsequently, if the transmitting unit 250 determines that the viewing condition has been changed by using the extracted viewing information, it transmits the extracted viewing information to the service server 300 to request an advertisement suitable for the changed viewing condition (steps S260 and S270).

In this regard, when the viewing information is received from the terminal 200 and the advertisement is requested, the service server 300 checks a specific broadcast channel currently viewed by the viewer using the viewing information received from the terminal 200 and provides the terminal 200 with the advertisement suitable for the broadcast content currently broadcasted on the specific broadcast channel.

As set forth above, in the method performed in the advertising system and the terminal 200 according to an exemplary embodiment of the present disclosure, targeted advertisements can be provided to viewers without combining broadcast contents with advertisements, in such a manner that the terminal 200 carried by a viewer checks a viewing condition of the viewer based on a beacon signal transmitted from the viewing device 100, and the separate service server 300 provides a targeted advertisement to the terminal 200 by using the viewing condition checked by the terminal 200.

The functional operations and implementations of the subject matter described herein may be implemented as digital electronic circuitry, or may be implemented in computer software, firmware, hardware, including the structures disclosed herein and structural equivalents thereof, or one or more combinations thereof. Implementations of the subject matter described herein may be implemented in one or more computer program products, in other words, one or more modules of computer program instructions encoded on a tangible program storage medium to control operation of a processing system or to be executed by the processing system.

The computer-readable medium may be a machine-readable storage device, a machine-readable storage substrate, a memory device, a composition of material that affects the machine-readable radio wave type signal, or one or more combinations thereof.

As used herein, “system” or “device” includes all kinds of apparatuses and machines for processing data including, for example, a programmable processor, a computer, a multiprocessor, or a computer. In addition to the hardware, the processing system may include, e.g., a code configuring processor firmware, and a code configuring an execution environment for the computer program upon request of, for example, a protocol stack, a database management system, an operating system, or one or more combinations thereof, or the like.

A computer program (also known as a program, software, a software application, a script or a code) may be written in any form of a programming language including a compiled or interpreted language, or a priori or procedural language, and may be deployed in any form including independent programs or modules, components, subroutines, or other units suitable for use in a computer environment. The computer program may not necessarily correspond to a file in a file system. The program may be stored in a single file provided to the requested program, in multiple interactive files (for example, a file storing one or more modules, subprograms or portions of a code), or in a part of a file (for example, one or more scripts stored in a markup language document) containing other programs or data. The computer program may be located on one site or distributed across multiple sites such that it is deployed to run on multiple computers interconnected by a communications network or on one computer.

The computer readable media suitable for storing computer program instructions and data may include, for example, semiconductor memory devices such as an EPROM, an EEPROM and flash memory devices, all sort of non-volatile memories including magnetic disks such as internal hard disks or external disks, and magnetic optical disks, CD-ROM and DVD-ROM disks, a media, and memory devices. A processor and a memory may be supplemented by special purpose logic circuits or integrated therewith.

Implementations of the subject matter described herein may be realized on an arithmetic system including, for example, a back-end component such as a data server, a middleware component such as an application server, a front-end component such as a client computer with a web browser or a graphical user interface allowing a user to interact with the implementations of the subject matter described herein, or one or more combinations of the back-end component, the middleware component, and the front-end component. The components of the system may be interconnected by any form or medium of digital data communications such as, for example, a communication network.

While the present disclosure includes a number of specific implementation details, they are not to be construed as limitations on any invention or the claimable scope. Rather, it should be understood as a description of features that may be specific to a particular embodiment of a particular invention. Similarly, the specific features described herein in the context of individual embodiments may be implemented in combination in a single embodiment. Alternatively, various features described in the context of a single embodiment may also be implemented in multiple embodiments individually or in any suitable sub-combination. Further, although the features may be described as operating in a particular combination and initially claimed as such, one or more features from the claimed combination may in some cases be excluded from the combination, and the claimed combination may be altered to a variant of a sub-combination or sub-combination.

Also, while the present disclosure illustrates operations in the drawings in a particular order, it should not be understood that such operations must be performed in that particular order or sequential order shown in the drawings in order to obtain a desired result, or that all illustrated operations should be performed. In certain cases, multitasking and parallel processing may be advantageous. Also, the separation of the various system components of the above described embodiments should not be understood as requiring such separation in all embodiments, and it should be understood that the program components and systems described above may generally be integrated together into a single software product or packaged into multiple software products.

As such, the present disclosure is not intended to limit the inventions to the specific terms disclosed herein. Thus, although the present disclosure has been described in detail with reference to the above examples, those skilled in the art would conceive alternations, modifications, and deformations on these examples without departing from the scope of the present disclosure. The scope of the present disclosure is defined by the appended claims rather than the description, and it should be construed that all alternations and modifications derived from the meaning and scope of the appended claims and their equivalents are included within the scope of the present disclosure.

1. A terminal comprising:
an extracting unit configured to extract viewing information from a beacon signal received from a viewing device;
a checking unit configured to check if a viewing condition associated with the viewing device has been changed based on the viewing information; and
a transmitting unit configured to transmit the viewing information to a service server so that an advertisement associated with the changed viewing condition is received from the service server, when it is determined that the viewing condition has been changed.

2. The terminal of claim 1, further comprising:
a determining unit configured to determine whether the terminal is able to receive the beacon signal; and
a switching unit configured to switch beacon reception capability from an inactive state to an active state to allow the terminal to receive the beacon signal, when it is determined that the terminal is able to receive the beacon signal.

3. The terminal of claim 2, wherein the determining unit determines that the terminal is able to receive the beacon signal when the terminal has entered a predetermined broadcast viewing area, and
wherein the broadcast viewing area is set as an area where the terminal has received an advertisement and/or an area where a predetermined function of the terminal has executed at a particular time zone.

4. The terminal of claim 1, wherein the viewing information contains at least one of a power state of the viewing device, a channel state of the viewing device and a spacing distance between the viewing device and the terminal, and
wherein the checking unit determines that the viewing condition has been changed when at least one of the power state, the channel state and the spacing distance has been changed.

5. A method performed by a terminal, comprising:
extracting viewing information from a beacon signal received from a viewing device;
checking if a viewing condition associated with the viewing device has been changed based on the viewing information; and
when it is determined that the viewing condition has been changed, transmitting the viewing information to a service server so that an advertisement associated with the changed viewing condition is received from the service server.

6. The method of claim 5, further comprising:
prior to the extracting, determining whether the terminal is able to receive the beacon signal; and
switching beacon reception capability from an inactive state to an active state to allow the terminal to receive the beacon signal, when it is determined that the terminal is able to receive the beacon signal.

7. The method of claim 6, wherein the determining comprises determining that the terminal is able to receive the beacon signal when the terminal has entered a predetermined broadcast viewing area, and
wherein the broadcast viewing area is set as an area where the terminal has received the advertisement and/or an area where a predetermined function of the terminal has executed at a particular time zone.

8. The method of claim 5, wherein the beacon signal contains at least one of a power state of the viewing device, a channel state of the viewing device and a spacing distance between the viewing device and the terminal, and
wherein the checking comprises determining that the viewing condition has been changed if at least one of the power state, the channel state and the spacing distance has been changed.
